(19) United States
(12) Patent Application Publication
(10) Pub. No.: US 2007/0223590 A1
(43) Pub. Date: Sep. 27, 2007

(54) SYSTEM, APPARATUS, METHOD, AND COMPUTER PROGRAM PRODUCT FOR PROCESSING AN INTEGER TRANSFORM

(75) Inventor: Siwei Ma, Los Angeles, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MEDIATEK INC., Hsin-Chu City (TW)

(21) Appl. No.: 11/456,895

(22) Filed: Jul. 12, 2006

Related U.S. Application Data
(60) Provisional application No. 60/743,725, filed on Mar. 24, 2006.

(51) Int. Cl. H04N 11/04; H04N 7/12

(52) U.S. Cl. 375/240.18; 375/240.26

(57) ABSTRACT

Systems, apparatuses, methods, and computer program products for processing a 2N×2N integer transform in image and video coding are provided. The 2N×2N integer transform involves a 2N×2N transform matrix, T_{2N×2N}. The apparatus comprises a retrieval unit, a generator, and a calculation unit. The retrieval unit is used for retrieving elements of the 2N×2N transform matrix, T_{2N×2N}. The generator is used for generating an N×N transform matrix, T_{N×N}, in response to the retrieved elements. The calculation unit is used for deriving a result from the 2N×2N integer transform by processing T_{N×N}.

### CROSS-REFERENCES TO RELATED APPLICATIONS

This application claims the benefit of U.S. Provisional Patent Application Ser. No. 60/743,725 filed Mar. 24, 2006, entitled “Fully Compatible Low Complexity Integer Transform” which is herein incorporated by reference in its entirety.

### BACKGROUND OF THE INVENTION

1. Field of the Invention

The present invention relates to integer transforms of encoding and decoding for image and video signals; specifically, the invention relates to factorizing a 2N×2N integer transform into an N×N integer transform in the field of image and video coding.

2. Descriptions of the Related Art

Integer transforms have been widely used in the latest video coding standards, such as H.264, VC-1, and Audio Video Standard (AVS), because of their complete reversibility and low complexity.

Integer transforms of video coding in the prior art have mainly focused on the creation of integer transform matrices. In U.S. Pat. No. 6,990,506, optimized values of an integer transform matrix are derived so that the integer transformation can satisfy certain normalization constraints and, moreover, minimize frequency distortion in the integer transform matrices. U.S. Pat. No. 6,856,262 discloses a limited value range which is defined to obtain approximate integer cosine transform coefficients. The transform coefficients are derived by considering the orthogonality and certain defined rules, whereby the provided method suggests use of a uniform normalization and quantization factor for all coefficients in quantization and normalization.

In addition, U.S. Pat. No. 6,882,685 discloses a method which reduces computational complexity of integer transforms. The method requires only four addition operations and one shift operation per coefficient transformation in a de-quantization process.

Although the applications of integer transform are more convenient in the aforementioned prior art, there are drawbacks. For example, as the size of an involved integer transform matrix increases, the computational complexity also increases exponentially. This drawback would increase the cost of commercializing video coding apparatuses using integer transforms. Consequently, a solution that can reduce computational complexity is highly demanded in the industrial field.

### SUMMARY OF THE INVENTION

An object of this invention is to provide an apparatus for processing a 2N×2N integer transform in image and video coding. The 2N×2N integer transform involves a 2N×2N transform matrix

$${T}_{2 N \times 2 N} = [ \begin{matrix}{A}_{0} \\ {A}_{1} \\ ⋮ \\ {A}_{2 N - 1}\end{matrix} ] .$$

A rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1}. . . m_{k,1} m_{k,0}], wherein N is a positive integer, k is one of zero and a positive integer, and k<N. The apparatus comprises a retrieval unit, a generator, and a calculation unit. The retrieval unit is used for retrieving Bₖ. The generator is used for generating an N×N transform matrix T_{N×N} by performing an assignment of

$${T}_{N \times N} = [ \begin{matrix}{B}_{0} \\ {B}_{1} \\ ⋮ \\ {B}_{N - 1}\end{matrix} ] .$$

The calculation unit is used for deriving a result of the 2N×2N integer transform by processing the T_{N×N}.

Another object of this invention is to provide a method for processing a 2N×2N integer transform in image and video coding. The 2N×2N integer transform involves a 2N×2N transform matrix

$${T}_{2 N \times 2 N} = [ \begin{matrix}{A}_{0} \\ {A}_{1} \\ ⋮ \\ {A}_{2 N - 1}\end{matrix} ] .$$

A rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘ and Bₖ^{*}=[m_{k,2N-1} . . . m_{k,1} m_{k,0}], wherein N is a positive integer, k is one of zero and a positive integer, and k<N. The method comprises the steps of: retrieving Bₖ; generating an N×N transform matrix T_{N×N} by performing an assignment of

$${T}_{N \times N} = [ \begin{matrix}{B}_{0} \\ {B}_{1} \\ ⋮ \\ {B}_{N - 1}\end{matrix} ] ;$$

and deriving a result of the 2N×2N integer transform by processing the T_{N×N}.

Another object of this invention is to provide an apparatus for processing a 2N×2N integer transform in image and video coding. The 2N×2N integer transform involves a 2N×2N transform matrix

$${T}_{2 N \times 2 N} = [ \begin{matrix}{A}_{0} \\ {A}_{1} \\ ⋮ \\ {A}_{2 N - 1}\end{matrix} ] .$$

A rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2-1}┘, and Bₖ^{*}=[m_{k,2N-1} . . . m_{k,1} m_{k,0}], wherein N is a positive integer, k is one of zero and a positive integer, and k<N. The apparatus comprises: means for retrieving Bₖ; means for generating an N×N transform matrix T_{N×N} by performing an assignment of

$${T}_{N \times N} = [ \begin{matrix}{B}_{0} \\ {B}_{1} \\ ⋮ \\ {B}_{N - 1}\end{matrix} ] ;$$

and means for deriving a result of the 2N×2N integer transform by processing the T_{N×N}.

A further object of this invention is to provide a system for processing a 2N×2N integer transform in image and video coding. The 2N×2N integer transform involves a 2N×2N transform matrix

$${T}_{2 N \times 2 N} = [ \begin{matrix}{A}_{0} \\ {A}_{1} \\ ⋮ \\ {A}_{2 N - 1}\end{matrix} ] .$$

A rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1} . . . m_{k,1} m_{k,0}], wherein N is a positive integer, k is one of zero and a positive integer, and k<N. The system comprises a processor. The processor is used for retrieving Bₖ, generating an N×N transform matrix T_{N×N} by performing an assignment of

$${T}_{N \times N} = [ \begin{matrix}{B}_{0} \\ {B}_{1} \\ ⋮ \\ {B}_{N - 1}\end{matrix} ] ,$$

and deriving a result of the 2N×2N integer transform by processing the T_{N×N}.

Yet a further object of this invention is to provide a computer program product for storing a computer program to execute a method for processing a 2N×2N integer transform in image and video coding. The 2N×2N integer transform involves a 2N×2N transform matrix

$${T}_{2 N \times 2 N} = [ \begin{matrix}{A}_{0} \\ {A}_{1} \\ ⋮ \\ {A}_{2 N - 1}\end{matrix} ] .$$

A rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1} . . . m_{k,1} m_{k,0}], wherein N is a positive integer, k is one of zero and a positive integer, and k<N. The computer program comprises: code for retrieving Bₖ; code for generating an N×N transform matrix T_{N×N} by performing an assignment of

$${T}_{N \times N} = [ \begin{matrix}{B}_{0} \\ {B}_{1} \\ ⋮ \\ {B}_{N - 1}\end{matrix} ] ;$$

and code for deriving a result of the 2N×2N integer transform by processing the T_{N×N}.

The present invention is capable of factorizing a 2N×2N integer transform in image and video coding into an N×N integer transform so that computational complexity of the image and video coding can be greatly reduced.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a first embodiment of this invention;

FIG. 2 illustrates how a calculation unit of the first embodiment transforms a data matrix into a resultant matrix; and

FIG. 3 illustrates a second embodiment of this invention.

### DESCRIPTION OF THE PREFERRED EMBODIMENT

The present invention provides systems, apparatuses, methods, and computer program products to process a 2N×2N integer transform during image and video coding in a more efficient fashion. More particularly, the present invention reduces the size of a 2N×2N integer transform matrix to an N×N integer transform matrix while implementing an integer transform. The N×N integer transform matrix is then processed instead of the 2N×2N integer transform matrix. After the integer transform is complete, a result of the integer transform is re-sized.

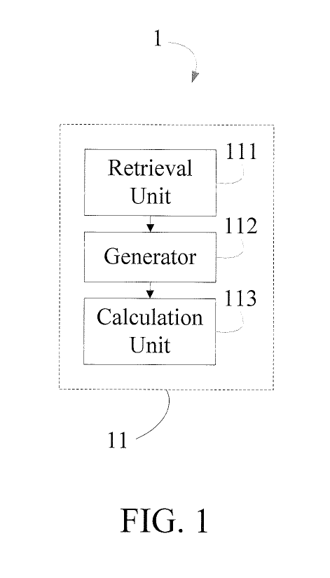

FIG. 1 illustrates a first embodiment of this invention, in which a system 1 for processing a 2N×2N integer transform in image and video coding is depicted. In particular, the system 1 is adapted for a discrete cosine transform in the standard, H.264. The discrete cosine transform is used to transform a data matrix, C_{M×2N}, received by the system 1 via a 2N×2N transform matrix, T_{2N×2N}, wherein N is a positive integer, M=2N/ 2^{x}, x is zero or a positive integer, and x is no larger than log₂(2N). For example, if N=8, x can be 0, 1, 2, 3, or 4 and M would be 16, 8, 4, 2, or 1, respectively. The following descriptions are based on N=8.

The 16×16 integer transform matrix T_{16×16} can be expressed as:

$${T}_{16 \times 16} = [ \begin{matrix}{A}_{0} \\ {A}_{1} \\ {A}_{2} \\ {A}_{3} \\ {A}_{4} \\ {A}_{5} \\ {A}_{6} \\ {A}_{7} \\ {A}_{8} \\ {A}_{9} \\ {A}_{10} \\ {A}_{11} \\ {A}_{12} \\ {A}_{13} \\ {A}_{14} \\ {A}_{15}\end{matrix} ] = [ \begin{matrix}{a}_{1} & {a}_{1} & {a}_{1} & {a}_{1} & {a}_{1} & {a}_{1} & {a}_{1} & {a}_{1} & {a}_{1} & {a}_{1} & {a}_{1} & {a}_{1} & {a}_{1} & {a}_{1} & {a}_{1} & {a}_{1} \\ {a}_{1} & {a}_{1} & {a}_{1} & {a}_{1} & {a}_{1} & {a}_{1} & {a}_{1} & {a}_{1} & - {a}_{1} & - {a}_{1} & - {a}_{1} & - {a}_{1} & - {a}_{1} & - {a}_{1} & - {a}_{1} & - {a}_{1} \\ {a}_{2} & {a}_{3} & {a}_{4} & {a}_{5} & - {a}_{5} & - {a}_{4} & - {a}_{3} & - {a}_{2} & - {a}_{2} & - {a}_{3} & - {a}_{4} & - {a}_{5} & {a}_{5} & {a}_{4} & {a}_{3} & {a}_{2} \\ {a}_{2} & {a}_{3} & {a}_{4} & {a}_{5} & - {a}_{5} & - {a}_{4} & - {a}_{3} & - {a}_{2} & {a}_{2} & {a}_{3} & {a}_{4} & {a}_{5} & - {a}_{5} & - {a}_{4} & - {a}_{3} & - {a}_{2} \\ {a}_{6} & {a}_{7} & - {a}_{7} & - {a}_{6} & - {a}_{6} & - {a}_{7} & {a}_{7} & {a}_{6} & {a}_{6} & {a}_{7} & - {a}_{7} & - {a}_{6} & - {a}_{6} & - {a}_{7} & {a}_{7} & {a}_{6} \\ {a}_{6} & {a}_{7} & - {a}_{7} & - {a}_{6} & - {a}_{6} & - {a}_{7} & {a}_{7} & {a}_{6} & - {a}_{6} & - {a}_{7} & {a}_{7} & {a}_{6} & {a}_{6} & {a}_{7} & - {a}_{7} & - {a}_{6} \\ {a}_{3} & - {a}_{5} & - {a}_{2} & - {a}_{4} & {a}_{4} & {a}_{2} & {a}_{5} & - {a}_{3} & - {a}_{3} & {a}_{5} & {a}_{2} & {a}_{4} & - {a}_{4} & - {a}_{2} & - {a}_{5} & {a}_{3} \\ {a}_{3} & - {a}_{5} & - {a}_{2} & - {a}_{4} & {a}_{4} & {a}_{2} & {a}_{5} & - {a}_{3} & {a}_{3} & - {a}_{5} & - {a}_{2} & - {a}_{4} & {a}_{4} & {a}_{2} & {a}_{5} & - {a}_{3} \\ {a}_{1} & - {a}_{1} & - {a}_{1} & {a}_{1} & {a}_{1} & - {a}_{1} & - {a}_{1} & {a}_{1} & {a}_{1} & - {a}_{1} & - {a}_{1} & {a}_{1} & {a}_{1} & - {a}_{1} & - {a}_{1} & {a}_{1} \\ {a}_{1} & - {a}_{1} & - {a}_{1} & {a}_{1} & {a}_{1} & - {a}_{1} & - {a}_{1} & {a}_{1} & - {a}_{1} & {a}_{1} & {a}_{1} & - {a}_{1} & - {a}_{1} & {a}_{1} & {a}_{1} & - {a}_{1} \\ {a}_{4} & - {a}_{2} & {a}_{5} & {a}_{3} & - {a}_{3} & - {a}_{5} & {a}_{2} & - {a}_{4} & - {a}_{4} & {a}_{2} & - {a}_{5} & - {a}_{3} & {a}_{3} & {a}_{5} & - {a}_{2} & {a}_{4} \\ {a}_{4} & - {a}_{2} & {a}_{5} & {a}_{3} & - {a}_{3} & - {a}_{5} & {a}_{2} & - {a}_{4} & {a}_{4} & - {a}_{2} & {a}_{5} & {a}_{3} & - {a}_{3} & - {a}_{5} & - {a}_{2} & - {a}_{4} \\ {a}_{7} & - {a}_{6} & {a}_{6} & - {a}_{7} & - {a}_{7} & {a}_{6} & - {a}_{6} & {a}_{7} & {a}_{7} & - {a}_{6} & {a}_{6} & - {a}_{7} & - {a}_{7} & {a}_{6} & - {a}_{6} & {a}_{7} \\ {a}_{7} & - {a}_{6} & {a}_{6} & - {a}_{7} & - {a}_{7} & {a}_{6} & - {a}_{6} & {a}_{7} & - {a}_{7} & {a}_{6} & - {a}_{6} & {a}_{7} & {a}_{7} & - {a}_{6} & {a}_{6} & - {a}_{7} \\ {a}_{5} & - {a}_{4} & {a}_{3} & - {a}_{2} & {a}_{2} & - {a}_{3} & {a}_{4} & - {a}_{5} & - {a}_{5} & {a}_{4} & - {a}_{3} & {a}_{2} & - {a}_{2} & {a}_{3} & - {a}_{4} & {a}_{5} \\ {a}_{5} & - {a}_{4} & {a}_{3} & - {a}_{2} & {a}_{2} & - {a}_{3} & {a}_{4} & - {a}_{5} & {a}_{5} & - {a}_{4} & {a}_{3} & - {a}_{2} & {a}_{2} & - {a}_{3} & {a}_{4} & - {a}_{5}\end{matrix} ]$$

wherein the integer transform matrix follows a rule of A₂ₖ=└Bₖ Bₖ^{*}┘, A₂ₖ₊₁└Bₖ −Bₖ^{*}┘, Bₖ=└m_{k,0} m_{k,1} . . . m_{k,2N-1}┘, and Bₖ^{*}=[m_{k,2N-1} . . . m_{k,1} m_{k,0}]. k is one of zero and a positive integer and is smaller than N.

Referring to FIG. 1, the system 1 comprises a processor 11. The processor 11 comprises a retrieval unit 111, a generator 112, and a calculation unit 113. The retrieval unit 111 is used for retrieving Bₖ. The generator 112 is used for generating an 8×8 transform matrix, T_{8×8}, by performing

$${T}_{8 \times 8} [ \begin{matrix}{B}_{0} \\ {B}_{1} \\ ⋮ \\ {B}_{7}\end{matrix} ] .$$

T_{8×8} is generated for reducing the calculation amount from processing the aforementioned 16×16 transform. The 8×8 transform matrix can be expressed as:

$${T}_{8 \times 8} = [ \begin{matrix}{B}_{0} \\ {B}_{1} \\ {B}_{2} \\ {B}_{3} \\ {B}_{4} \\ {B}_{5} \\ {B}_{6} \\ {B}_{7}\end{matrix} ] = [ \begin{matrix}{a}_{1} & {a}_{1} & {a}_{1} & {a}_{1} & {a}_{1} & {a}_{1} & {a}_{1} & {a}_{1} \\ {a}_{2} & {a}_{3} & {a}_{4} & {a}_{5} & - {a}_{5} & - {a}_{4} & - {a}_{3} & - {a}_{2} \\ {a}_{6} & {a}_{7} & - {a}_{7} & - {a}_{6} & - {a}_{6} & - {a}_{7} & {a}_{7} & {a}_{6} \\ {a}_{3} & - {a}_{5} & - {a}_{2} & - {a}_{4} & {a}_{4} & {a}_{2} & {a}_{5} & - {a}_{3} \\ {a}_{1} & - {a}_{1} & - {a}_{1} & {a}_{1} & {a}_{1} & - {a}_{1} & - {a}_{1} & {a}_{1} \\ {a}_{4} & - {a}_{2} & {a}_{5} & {a}_{3} & - {a}_{3} & - {a}_{5} & {a}_{2} & - {a}_{4} \\ {a}_{7} & - {a}_{6} & {a}_{6} & - {a}_{7} & - {a}_{7} & {a}_{6} & - {a}_{6} & {a}_{7} \\ {a}_{5} & - {a}_{4} & {a}_{3} & - {a}_{2} & {a}_{2} & - {a}_{3} & {a}_{4} & - {a}_{5}\end{matrix} ] .$$

The calculation unit 113 is used for deriving a result from the 16×16 integer transform by processing T_{8×8}.

For example, the above T_{16×16} transform matrix may be:

$${T}_{16 \times 16} = [ \begin{matrix}{A}_{0} \\ {A}_{1} \\ {A}_{2} \\ {A}_{3} \\ {A}_{4} \\ {A}_{5} \\ {A}_{6} \\ {A}_{7} \\ {A}_{8} \\ {A}_{9} \\ {A}_{10} \\ {A}_{11} \\ {A}_{12} \\ {A}_{13} \\ {A}_{14} \\ {A}_{15}\end{matrix} ] = [ \begin{matrix}8 & 8 & 8 & 8 & 8 & 8 & 8 & 8 & 8 & 8 & 8 & 8 & 8 & 8 & 8 & 8 \\ 8 & 8 & 8 & 8 & 8 & 8 & 8 & 8 & - 8 & - 8 & - 8 & - 8 & - 8 & - 8 & - 8 & - 8 \\ 12 & 10 & 6 & 3 & - 3 & - 6 & - 10 & - 12 & - 12 & - 10 & - 6 & - 3 & 3 & 6 & 10 & 12 \\ 12 & 10 & 6 & 3 & - 3 & - 6 & - 10 & - 12 & 12 & 10 & 6 & 3 & - 3 & - 6 & - 10 & - 12 \\ 8 & 4 & - 4 & - 8 & - 8 & - 4 & 4 & 8 & 8 & 4 & - 4 & - 8 & - 8 & - 4 & 4 & 8 \\ 8 & 4 & - 4 & - 8 & - 8 & - 4 & 4 & 8 & - 8 & - 4 & 4 & 8 & 8 & 4 & - 4 & - 8 \\ 10 & - 3 & - 12 & - 6 & 6 & 12 & 3 & - 10 & - 10 & 3 & 12 & 6 & - 6 & - 12 & - 3 & 10 \\ 10 & - 3 & - 12 & - 6 & 6 & 12 & 3 & - 10 & 10 & - 3 & - 12 & - 6 & 6 & 12 & 3 & - 10 \\ 8 & - 8 & - 8 & 8 & 8 & - 8 & - 8 & 8 & 8 & - 8 & - 8 & 8 & 8 & - 8 & - 8 & 8 \\ 8 & - 8 & - 8 & 8 & 8 & - 8 & - 8 & 8 & - 8 & 8 & 8 & - 8 & - 8 & 8 & 8 & - 8 \\ 6 & - 12 & 3 & 10 & - 10 & - 3 & 12 & - 6 & - 6 & 12 & - 3 & - 10 & 10 & 3 & - 12 & 6 \\ 6 & - 12 & 3 & 10 & - 10 & - 3 & 12 & - 6 & 6 & - 12 & 3 & 10 & - 10 & - 3 & 12 & - 6 \\ 4 & - 8 & 8 & - 4 & - 4 & 8 & - 8 & 4 & 4 & - 8 & 8 & - 4 & - 4 & 8 & - 8 & 4 \\ 4 & - 8 & 8 & - 4 & - 4 & 8 & - 8 & 4 & - 4 & 8 & - 8 & 4 & 4 & - 8 & 8 & - 4 \\ 3 & - 6 & 10 & - 12 & 12 & - 10 & 6 & - 3 & - 3 & 6 & - 10 & 12 & - 12 & 10 & - 6 & 3 \\ 3 & - 6 & 10 & - 12 & 12 & - 10 & 6 & - 3 & 3 & - 6 & 10 & - 12 & 12 & - 10 & 6 & - 3\end{matrix} ] .$$

The retrieval unit 111 retrieves B₀, B₁, B₂, B₃, B₄, B₅, B₆, and B₇ based on the rule. That is, the retrieval unit 111 retrieves B₀=[8 8 8 8 8 8 8 8], B₁=[12 10 6 3 −3 −6 −10 −12], B₂=[8 4 −4 −8 −8 −4 4 8], B₃=[10 −3 −12 −6 6 12 3 −10], B₄=[8 −8 −8 8 8 −8 −8 8], B₅=[6 −12 3 10 −10 −3 12 −6], B₆=[4 −8 8 −4 −4 8 −8 4], and B₇=[3 −6 10 −12 12 −10 6 −3]. Accordingly, the generator 112 forms the T_{8×8} as:

$${T}_{8 \times 8} = [ \begin{matrix}{B}_{0} \\ {B}_{1} \\ ⋮ \\ {B}_{7}\end{matrix} ] = [ \begin{matrix}8 & 8 & 8 & 8 & 8 & 8 & 8 & 8 \\ 12 & 10 & 6 & 3 & - 3 & - 6 & - 10 & - 12 \\ 8 & 4 & - 4 & - 8 & - 8 & - 4 & 4 & 8 \\ 10 & - 3 & - 12 & - 6 & 6 & 12 & 3 & - 10 \\ 8 & - 8 & - 8 & 8 & 8 & - 8 & - 8 & 8 \\ 6 & - 12 & 3 & 10 & - 10 & - 3 & 12 & - 6 \\ 4 & - 8 & 8 & - 4 & - 4 & 8 & - 8 & 4 \\ 3 & - 6 & 10 & - 12 & 12 & - 10 & 6 & - 3\end{matrix} ] .$$

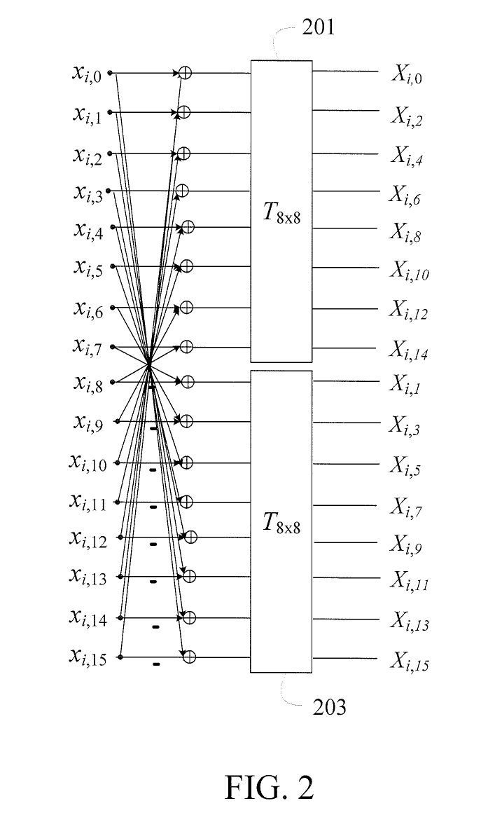

Thereafter, the calculation unit 113 derives the result of the 16×16 integer transform by processing T_{8×8}, i.e., by applying the T_{8×8} to the data matrix C_{M×16} as illustrated in FIG. 2, wherein the data matrix

$${C}_{M \times 16} = [ \begin{matrix}{c}_{0} \\ {c}_{1} \\ ⋮ \\ {c}_{M - 1}\end{matrix} ] = [ \begin{matrix}{x}_{0 , 0} & ⋯ & {x}_{0 , 15} \\ {x}_{1 , 1} & ⋯ & {x}_{1 , 15} \\ ⋮ & & ⋮ \\ {x}_{M - 1 , 0} & ⋯ & {x}_{M - 1 , 15}\end{matrix} ] .$$

The calculation unit 113 calculates a resultant matrix

$${D}_{M \times 16} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 15} \\ {X}_{1 , 1} & ⋯ & {X}_{1 , 15} \\ ⋮ & & ⋮ \\ {X}_{M - 1 , 0} & ⋯ & {X}_{M - 1 , 15}\end{matrix} ]$$

by using the following two equations:
└X_{i,0} X_{i,2} . . . X_{i,14}┘=└x_{i,0}+x_{i,15} x_{i,1}+x_{i,4} . . . x_{i,7}+x_{i,8}┘×T_{8×8} and
└X_{i,1} X_{i,3} . . . X_{i,15}┘=└x_{i,0}−x_{i,15} x_{i,1}−x_{i,4} . . . x_{i,7}−x_{i,8}┘×T_{8×8},
wherein, i is an integer between the values of 0 to M−1. As shown in FIG. 2, each row of the resultant matrix, D_{M×16}, is achieved by 16 operations (8 addition operations and 8 subtraction operations) and two 8×8 integer transforms 201, 203. Each of the integer transforms 201, 203 is achieved by considering T_{8×8}. The outputs of the two 8×8 integer transforms 201, 203 form the resultant matrix D_{M×16}. After the resultant matrix D_{M×16} is formed, the generator 112 further generates an M×M transform matrix, T_{M×M}, by following the above-mentioned rule and assignment. The result of the discrete cosine transform can be derived by performing T_{M×M}×D_{M×2N}. For other cases in which the 2N×2N integer transform is an inverse discrete cosine transform, the result of the inverse discrete cosine transform can be derived by performing T_{M×M}^{T}×D_{M×2N}.

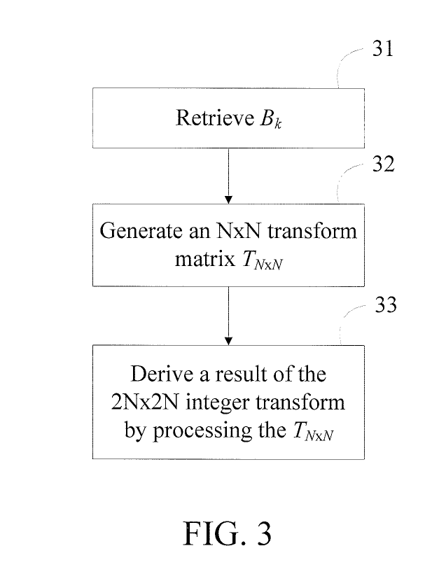

FIG. 3 illustrates a second embodiment of this invention, which is a method for processing a 2N×2N integer transform in image and video coding. The 2N×2N integer transform, the 2N×2N transform matrix, the rule of T_{2N×2N}, and the assignment of T_{N×N} are similar to those described in the first embodiment. As FIG. 3 shows, the second embodiment executes step 31 to retrieve Bₖ. Then, step 32 is executed to generate an N×N transform matrix, T_{N×N}, by performing the assignment of

$${T}_{N \times N} = [ \begin{matrix}{B}_{0} \\ {B}_{1} \\ ⋮ \\ {B}_{N - 1}\end{matrix} ] .$$

Finally, step 33 is executed to derive a result from the 2N×2N integer transform by processing T_{N×N} Step 33 comprises the calculation of the resultant matrix

$${D}_{M \times 2 N} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 2 N - 1} \\ {X}_{1 , 1} & ⋯ & {X}_{1 , 2 N - 1} \\ ⋮ & & ⋮ \\ {X}_{M - 1 , 0} & ⋯ & {X}_{M - 1 , 2 N - 1}\end{matrix} ]$$

according to T_{N×N}, wherein
└X_{i,0} X_{i,2} . . . X_{i,2N}┘=└x_{i,0}+x_{i,2N-1} x_{i,1}+x_{i,2N-1} . . . x_{i,N-1}+x_{i,N}┘×T_{N×N}, and
└X_{i,1} X_{i,3} . . . X_{i,2N-1}┘=└x_{i,0}−x_{i,2N-2} x_{i,1}−x_{i,2N-2} . . . x_{i,N-1}−x_{i,N}┘×T_{N×N}.

In addition to the steps shown in FIG. 3, the second embodiment is capable of executing all operations or functions stated in the first embodiment.

A third embodiment of the present invention is a computer program product that stores a computer program which executes the method of the second embodiment. The computer program comprises: code for retrieving Bₖ; code for generating an N×N transform matrix, T_{N×N}, by performing

$${T}_{N \times N} = [ \begin{matrix}{B}_{0} \\ {B}_{1} \\ ⋮ \\ {B}_{N - 1}\end{matrix} ] ;$$

and code for deriving a result from the 2N×2N integer transform by processing T_{N×N}. The computer program product can be a floppy disk, a hard disk, an optical disc, a flash disk, a tape, a network accessible database or a storage medium with the same functionality known by those skilled in the art.

Although the above embodiments use N=8 as an example, N is not limited to this value. To be more specific, N can be any positive number.

The present invention factorizes a 2N×2N integer transform matrix into an N×N integer transform matrix to reduce the computational complexity during image and video coding. The cost of commercializing image and video coding apparatuses is, thus, saved, especially when the size of the transform matrix is large.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for processing a 2N×2N integer transform in image and video coding, the 2N×2N integer transform involving a 2N×2N transform matrix
$${T}_{2 N \times 2 N} = [ \begin{matrix}{A}_{0} \\ {A}_{1} \\ ⋮ \\ {A}_{2 N - 1}\end{matrix} ] ,$$
a rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1}. . . m_{k,1} m_{k,0}], N being a positive integer, k being one of zero and a positive integer and being smaller than N, the apparatus comprising:
a retrieval unit for retrieving Bₖ;
a generator for generating an N×N transform matrix T_{N×N} by performing an assignment of
$${T}_{N \times N} = [ \begin{matrix}{B}_{0} \\ {B}_{1} \\ ⋮ \\ {B}_{N - 1}\end{matrix} ] ;$$
and
a calculation unit for deriving a result of the 2N×2N integer transform by processing the T_{N×N}.

2. The apparatus of claim 1, the 2N×2N integer transform being processed in response to a data matrix
$${C}_{M \times 2 N} = [ \begin{matrix}{c}_{0} \\ {c}_{1} \\ ⋮ \\ {c}_{M - 1}\end{matrix} ] = [ \begin{matrix}{x}_{0 , 0} & ⋯ & {x}_{0 , 2 N - 1} \\ {x}_{1 , 1} & ⋯ & {x}_{1 , 2 N - 1} \\ ⋮ & & ⋮ \\ {x}_{M - 1 , 0} & ⋯ & {x}_{M - 1 , 2 N - 1}\end{matrix} ] ,$$
wherein the calculation unit derives the result by calculating a resultant matrix
$${D}_{M \times 2 N} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 2 N - 1} \\ {X}_{1 , 1} & ⋯ & {X}_{1 , 2 N - 1} \\ ⋮ & & ⋮ \\ {X}_{M - 1 , 0} & ⋯ & {X}_{M - 1 , 2 N - 1}\end{matrix} ]$$
according to the T_{N×N}, └X_{i,0} X_{i,2} . . . X_{i,2N-2}┘=└x_{i,0}+x_{i,2N-1} x_{i,1}+x_{i,2N-2} . . . x_{i,N-1}+x_{i,N}┘T^{N×N}, └X_{i,1} X_{i,3} . . . X_{i,2N-1}┘=└x_{i,0}+x_{i,2N-1} x_{i,1}−x_{i,2N-2} . . . x_{i,N-1}−x_{i,N}┘T^{N×N}, i is one of a zero and a positive number and is smaller than N, M=2N/2^{x}, and x is one of zero and a positive integer and not larger than log₂(2N).

3. The apparatus of claim 2, the 2N×2N integer transform being a discrete cosine transform, wherein the generator further generates an M×M transform matrix T_{M×M} by following the rule and the assignment, and the result is T_{M×M}×D_{M×2N}.

4. The apparatus of claim 2, the 2N×2N integer transform being an inverse discrete cosine transform, wherein the generator further generates an M×M transform matrix T_{M×M} by following the rule and the assignment, and the result is T_{M×M}^{T}×D_{M×2N}.

5. A method for processing a 2N×2N integer transform in image and video coding, the 2N×2N integer transform involving a 2N×2N transform matrix
$${T}_{2 N \times 2 N} = [ \begin{matrix}{A}_{0} \\ {A}_{1} \\ ⋮ \\ {A}_{2 N - 1}\end{matrix} ] ,$$
a rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1}. . . m_{k,1} m_{k,0}], N being a positive integer, k being one of zero and a positive integer and being smaller than N, the method comprising the steps of:
retrieving Bₖ;
generating an N×N transform matrix T_{N×N} by performing an assignment of
$${T}_{N \times N} = [ \begin{matrix}{B}_{0} \\ {B}_{1} \\ ⋮ \\ {B}_{N - 1}\end{matrix} ] ;$$
and
deriving a result of the 2N×2N integer transform by processing the T_{N×N}.

6. The method of claim 5, the 2N×2N integer transform being processed in response to a data matrix
$${C}_{M \times 2 N} = [ \begin{matrix}{c}_{0} \\ {c}_{1} \\ ⋮ \\ {c}_{M - 1}\end{matrix} ] = [ \begin{matrix}{x}_{0 , 0} & ⋯ & {x}_{0 , 2 N - 1} \\ {x}_{1 , 1} & ⋯ & {x}_{1 , 2 N - 1} \\ ⋮ & & ⋮ \\ {x}_{M - 1 , 0} & ⋯ & {x}_{M - 1 , 2 N - 1}\end{matrix} ] ,$$
wherein the deriving step comprises the step of calculating a resultant matrix
$${D}_{M \times 2 N} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 2 N - 1} \\ {X}_{1 , 1} & ⋯ & {X}_{1 , 2 N - 1} \\ ⋮ & & ⋮ \\ {X}_{M - 1 , 0} & ⋯ & {X}_{M - 1 , 2 N - 1}\end{matrix} ]$$
according to the T_{N×N}, └X_{i,0} X_{i,2} . . . X_{i,2N-2}┘=└x_{i,0}+x_{i,2N-1} x_{i,1}+x_{i,2N-2} . . . x_{i,N-1}+x_{i,N}┘×T_{N×N}, └X_{i,1} X_{i,3} . . . X_{i,2N-1}┘=└x_{i,0}−X_{i,2N-1} X_{i,1}−x_{i,2N-2} . . . x_{i,N-1}−x_{i,N}┘×T_{N×N}, i is one of a zero and a positive number and is smaller than N, M=2N/2^{x}, and x is one of zero and a positive integer and not larger than log₂(2N).

7. The method of claim 6, the 2N×2N integer transform being a discrete cosine transform, wherein the method further comprises the step of generating an M×M transform matrix T_{M×M} by following the rule and the assignment, and the result is T_{M×M}×D_{M×2N}.

8. The method of claim 6, the 2N×2N integer transform being an inverse discrete cosine transform, wherein the method further comprises the step of generating an M×M transform matrix T_{M×M} by following the rule and the assignment, and the result is T_{M×M}^{T}×D_{M×2N}.

9. An apparatus for processing a 2N×2N integer transform in image and video coding, the 2N×2N integer transform involving a 2N×2N transform matrix
$${T}_{2 N \times 2 N} = [ \begin{matrix}{A}_{0} \\ {A}_{1} \\ ⋮ \\ {A}_{2 N - 1}\end{matrix} ] ,$$
a rule of the T_{2N×2N} is A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1}. . . m_{k,1} m_{k,0}], N being a positive integer, k being one of zero and a positive integer and being smaller than N, the apparatus comprising:
means for retrieving Bₖ;
means for generating an N×N transform matrix T_{N×N} by performing an assignment of
$${T}_{N \times N} = [ \begin{matrix}{B}_{0} \\ {B}_{1} \\ ⋮ \\ {B}_{N - 1}\end{matrix} ] ;$$
and means for deriving a result of the 2N×2N integer transform by processing the T_{N×N}.

10. The apparatus of claim 9, the 2N×2N integer transform being processed in response to a data matrix
$${C}_{M \times 2 N} = [ \begin{matrix}{c}_{0} \\ {c}_{1} \\ ⋮ \\ {c}_{M - 1}\end{matrix} ] = [ \begin{matrix}{x}_{0 , 0} & ⋯ & {x}_{0 , 2 N - 1} \\ {x}_{1 , 1} & ⋯ & {x}_{1 , 2 N - 1} \\ ⋮ & & ⋮ \\ {x}_{M - 1 , 0} & ⋯ & {x}_{M - 1 , 2 N - 1}\end{matrix} ] ,$$
wherein the deriving means derives the result by calculating a resultant matrix
$${D}_{M \times 2 N} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 2 N - 1} \\ {X}_{1 , 1} & ⋯ & {X}_{1 , 2 N - 1} \\ ⋮ & & ⋮ \\ {X}_{M - 1 , 0} & ⋯ & {X}_{M - 1 , 2 N - 1}\end{matrix} ]$$
according to the T_{N×N}, └X_{i,0} X_{i,2} . . . X_{i,2N-2}┘=└x_{i,0}+x_{i,2N-1} x_{i,1}+x_{i,2N-2} . . . x_{i,N-1}+x_{i,N}┘×T_{N×N}, └X_{i,1} X_{i,3} . . . X_{i,2N-1}┘=└x_{i,0}−x_{i,2N-1} x_{i,1}−x_{i,2N-2} . . . x_{i,N-1}−x_{i,N}┘×T_{N×N}, i is one of a zero and a positive number and is smaller than N, M=2N/2^{x}, and x is one of zero and a positive integer and not larger than log₂(2N).

11. The apparatus of claim 10, the 2N×2N integer transform being a discrete cosine transform, wherein the generating means further generates an M×M transform matrix T_{M×M} by following the rule and the assignment, and the result is T_{M×M}×D_{M×2N}.

12. The apparatus of claim 10, the 2N×2N integer transform being an inverse discrete cosine transform, wherein the generating means further generates an M×M transform matrix T_{M×M} by following the rule and the assignment, and the result is T_{M×M}^{T}×D_{M×2N}.

13. A system for processing a 2N×2N integer transform in image and video coding, the 2N×2N integer transform involving a 2N×2N transform matrix
$${T}_{2 N \times 2 N} = [ \begin{matrix}{A}_{0} \\ {A}_{1} \\ ⋮ \\ {A}_{2 N - 1}\end{matrix} ] ,$$
a rule of the T_{2N×2N} is A₂ₖ=└Bₖ Bₖ^{*}┘, A₂ₖ₊₁=└Bₖ−Bₖ^{*}┘, Bₖ=└m_{k,0} m_{k,1} . . . m_{k,2N-1}┘, and Bₖ^{*}=[m_{k,2N-1}. . . m_{k,1} m_{k,0}], N being a positive integer, k being one of zero and a positive integer and being smaller than N, the system comprising:
a processor for retrieving Bₖ, generating an N×N transform matrix T_{N×N} by performing an assignment of
$${T}_{N \times N} = [ \begin{matrix}{B}_{0} \\ {B}_{1} \\ ⋮ \\ {B}_{N - 1}\end{matrix} ] ,$$
and deriving a result of the 2N×2N integer transform by processing the T_{N×N}.

14. The system of claim 13, the 2N×2N integer transform being processed in response to a data matrix
$${C}_{M \times 2 N} = [ \begin{matrix}{c}_{0} \\ {c}_{1} \\ ⋮ \\ {c}_{M - 1}\end{matrix} ] = [ \begin{matrix}{x}_{0 , 0} & ⋯ & {x}_{0 , 2 N - 1} \\ {x}_{1 , 1} & ⋯ & {x}_{1 , 2 N - 1} \\ ⋮ & & ⋮ \\ {x}_{M - 1 , 0} & ⋯ & {x}_{M - 1 , 2 N - 1}\end{matrix} ] ,$$
wherein the processor derives the result by calculating a resultant matrix
$${D}_{M \times 2 N} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 2 N - 1} \\ {X}_{1 , 1} & ⋯ & {X}_{1 , 2 N - 1} \\ ⋮ & & ⋮ \\ {X}_{M - 1 , 0} & ⋯ & {X}_{M - 1 , 2 N - 1}\end{matrix} ]$$
according to the T_{N×N}, └X_{i,0} X_{i,2} . . . X_{i,2N-2}┘=└x_{i,0}+x_{i,2N-1} x_{i,1}+x_{i,2N-2} . . . x_{i,N-1}+x_{i,N}┘×T_{N×N}, └X_{i,1} X_{i,3} . . . X_{i,2N-1}┘=└x_{i,0}−x_{i,2N-1} x_{i,1}−x_{i,2N-2} . . . x_{i,N-1}−x_{i,N}┘×T_{N×N}, i is one of a zero and a positive number and is smaller than N, M=2N/2^{x}, x is one of zero and a positive integer and not larger than log₂(2N), and the memory further stores the D_{M×2N}.

15. The system of claim 14, the 2N×2N integer transform being a discrete cosine transform, wherein the processor further generates an M×M transform matrix T_{M×M} by following the rule and the assignment, and the result is T_{M×M}×D_{M×2N}.

16. The system of claim 14, the 2N×2N integer transform being an inverse discrete cosine transform, wherein the processor further generates an M×M transform matrix T_{M×M} by following the rule and the assignment, and the result is T_{M×M}^{T}×D_{M×2N}.

17. The system of claim 13, wherein the processor comprises:
a retrieval unit for retrieving Bₖ;
a generator for generating the N×N transform matrix T_{N×N}; and
a calculation unit for deriving the result.

18. A computer program product for storing a computer program to execute a method for processing a 2N×2N integer transform in image and video coding, the 2N×2N integer transform involving a 2N×2N transform matrix
$${T}_{2 N \times 2 N} = [ \begin{matrix}{A}_{0} \\ {A}_{1} \\ ⋮ \\ {A}_{2 N - 1}\end{matrix} ] ,$$
a rule of the T_{2N×2N} being A₂ₖ=└Bₖ Bₖ^{*}┘, A₂ₖ₊₁=└Bₖ −Bₖ^{*}┘, Bₖ=└m_{k,0} m_{k,1} . . . m_{k,2N-1}┘, and Bₖ^{*}=[m_{k,2N-1} . . . m_{k,1} m_{k,0}], N being a positive integer, k being one of zero and a positive integer and being smaller than N, the computer program comprising:
code for retrieving Bₖ;
code for generating an N×N transform matrix T_{N×N} by performing an assignment of
$${T}_{N \times N} = [ \begin{matrix} {B}_{0} \\ {B}_{1} \\ ⋮ \\ {B}_{N - 1}\end{matrix} ] ;$$
and code for deriving a result of the 2N×2N integer transform by processing the T_{N×N}.

19. The computer program product of claim 18, the 2N×2N integer transform being processed in response to a data matrix
$${C}_{M \times 2 N} = [ \begin{matrix}{c}_{0} \\ {c}_{1} \\ ⋮ \\ {c}_{M - 1}\end{matrix} ] = [ \begin{matrix}{x}_{0 , 0} & ⋯ & {x}_{0 , 2 N - 1} \\ {x}_{1 , 1} & ⋯ & {x}_{1 , 2 N - 1} \\ ⋮ & & ⋮ \\ {x}_{M - 1 , 0} & ⋯ & {x}_{M - 1 , 2 N - 1}\end{matrix} ] ,$$
wherein the deriving code comprises code for calculating a resultant matrix
$${D}_{M \times 2 N} = [ \begin{matrix}{d}_{0} \\ {d}_{1} \\ ⋮ \\ {d}_{M - 1}\end{matrix} ] = [ \begin{matrix}{X}_{0 , 0} & ⋯ & {X}_{0 , 2 N - 1} \\ {X}_{1 , 1} & ⋯ & {X}_{1 , 2 N - 1} \\ ⋮ & & ⋮ \\ {X}_{M - 1 , 0} & ⋯ & {X}_{M - 1 , 2 N - 1}\end{matrix} ]$$
according to the TN×N └X_{i,0} X_{i,2} . . . X_{i,2N-2}┘=└x_{i,0}+x_{i,2N-1} x_{i,1}+x_{i,2N-2} . . . x_{i,N-1}+x_{i,N}┘×T_{N×N}, └X_{i,1} X_{i,3} . . . X_{i,2N-1}┘=└x_{i,0}−X_{i,2N-1} x_{i,1}−x_{i,2N-2} . . . x_{i,N-1}−x_{i,N}┘×T_{N×N}, i is one of a zero and a positive number and is smaller than N, M=2N/2^{x}, and x is one of zero and a positive integer and not larger than log₂(2N).

20. The computer program product of claim 19, the 2N×2N integer transform being a discrete cosine transform, wherein the computer program further comprises code for generating an M×M transform matrix T_{M×M} by following the rule and the assignment, and the result is T_{M×M}×D_{M×2N}.

21. The computer program product of claim 19, the 2N×2N integer transform being an inverse discrete cosine transform, wherein the computer program further comprises code for generating an M×M transform matrix T_{M×M} by following the rule and the assignment, and the result is T_{M×M}^{T}×D_{M×2N}.
